(19) United States
(12) Patent Application Publication
(10) Pub. No.: US 2012/0110890 A1
(43) Pub. Date: May 10, 2012

(54) BUCKET CONTAINING FLOATING NET FOR FISHING

(76) Inventor: Sanford Garrett, Kansas City, KS (US)

(21) Appl. No.: 12/943,866

(22) Filed: Nov. 10, 2010

(51) Int. Cl. A01K 97/20; A01K 75/04; A01K 97/00; A01K 97/06

(52) U.S. Cl. 43/55; 43/7; 43/54.1; 43/4

(57) ABSTRACT

A fish keeping system includes a bucket for storing a floating net assembly. The bucket may include a cushioned seat on a lid portion thereof to provide a seat for a user. The floating net assembly may be removed from the bucket and allowed to float in water. The floating net assembly may include a float ring on a top portion and a weighted lower ring to allow the net assembly to become elongated when disposed in water, such as a lake. A drawstring may be included at the lower end of the net assembly for easy removal of fish kept in the net. The net assembly may allow a fisherman to keep their catch in a more natural environment, without any physical restraint attached to the fish.

### BACKGROUND OF THE INVENTION

The present invention relates to buckets and, more particularly, to a bucket having a floating net adapted to be stored inside the bucket.

Fishermen, either when fishing from shore or from a boat, need a way to keep their catch alive and fresh. While larger boats may include a live well, not all boats are so equipped. Even when equipped with a live well, the water therewithin may get warm and/or stale/dirty over time. Shore fishermen may contain their catch on a line or a chain with clips that attach to the fish through their mouth and gills. With these lines/chains, it may be difficult to change locations and these systems may harm the fish.

In competition fishing, the catch must be kept alive for weighing and measuring and then released. People participating in this sport require a way to keep their catch alive and healthy.

As can be seen, there is a need for a system for keeping a fishing catch alive and healthy.

### SUMMARY OF THE INVENTION

In one aspect of the present invention, a fish keeping system comprises a bucket having a container portion and a lid portion; a net assembly adapted to fit inside the bucket; a float ring attached to one end of the net assembly; a first ring attached to a first end of a net extending from the float ring; and a second ring attached to the net proximal to an opening at a second end of the net.

In another aspect of the present invention, a bucketbasket comprises a bucket having a container portion and a lid portion; a net assembly adapted to fit inside the bucket; a float ring attached to one end of the net assembly; a first ring attached to a first end of a net extending from the float ring; a second ring attached to the net proximal to an opening at a second end of the net; a cushioned seat on an exterior surface of the lid; a handle for carrying the system; and a net assembly handle attached to and extending from the net assembly.

These and other features, aspects and advantages of the present invention will become better understood with reference to the following drawings, description and claims.

### BRIEF DESCRIPTION OF THE DRAWINGS

FIG. 1 is a perspective view of a bucketbasket in a closed position according to an embodiment of the present invention;

FIG. 2 is a perspective view of the bucketbasket of FIG. 1, in with its lid open;

FIG. 3 is an exploded view of the bucketbasket of FIG. 1, with a net assembly removed therefrom;

FIG. 4 is a top view of a net assembly according to an embodiment of the present invention;

FIG. 5 is a perspective view of the net assembly of FIG. 4; and

FIG. 6 is a close-up view of a lower portion of the net assembly of FIG. 4.

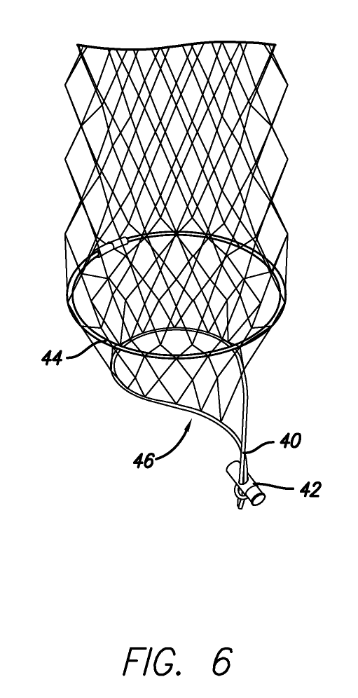

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a fish keeping system that includes a bucket for storing a floating net assembly. The bucket may include a cushioned seat on a lid portion thereof to provide a seat for a user. The floating net assembly may be removed from the bucket and allowed to float in water. The floating net assembly may include a float ring on a top portion and a weighted lower ring to allow the net assembly to become elongated when disposed in water, such as a lake. A drawstring may be included at the lower end of the net assembly for easy removal of fish kept in the net. The net assembly may allow a fisherman to keep their catch in a more natural environment, without any physical restraint attached to the fish.

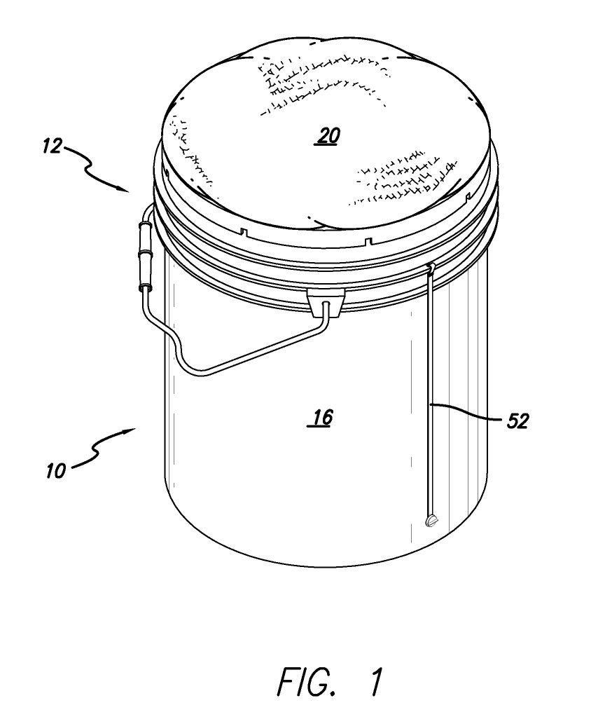

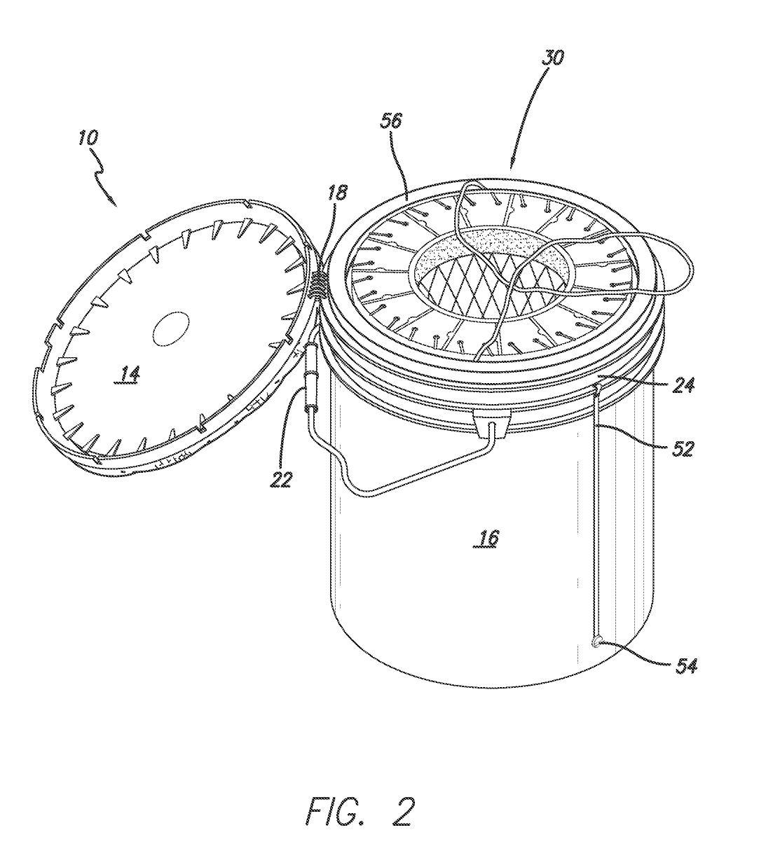

Referring to FIGS. 1 and 2, a bucketbasket 10 may include a bucket 12 having a lid 14 removable attached to a container 16. In some embodiments, the lid 14 may be attached to the container 16 with a hinge 18. The hinge 18 may be any type of hinge for attaching two components. For example, the hinge 18 may be formed from stitching that joins a portion of the lid 14 to a portion of the container 16. In other embodiments, the hinge may be a living hinge formed from a plastic material.

A seat 20 may be disposed on the outside surface of the lid 14. The seat 20 may be a cushioned seat for comfort of a user. The bucketbasket 10 may further include a handle 22 for portability of the bucketbasket 10. The handle 22 may be attached to the bucketbasket 10 by means known in art.

A plug 54 may be formed in a lower portion of the bucket 12 to help in filling or draining the bucket 12. The plug 54 may be, for example, a molded rubber plug that frictionally fits in a hole in the bucket 12. In some embodiments, the plug 54 may have threads to thread into the hole in the bucket 12. The plug 54 may be attached to the bucket 12 by a cord 52, such as an elastic cord. The cord 52 may connect to the plug 54 on one end to, for example, a hole in the rings around the top of the bucket 12. Alternatively, the cord 52 may connect to the handle 22 of the bucket 12.

The bucket 12 may be of any suitable style, size and design. For example, the bucket 12 may be a conventional 5-gallon round pail. In other embodiments, the bucket 12 may be larger or smaller, depending on the needs of the user. For example, a smaller bucket 12 may be used by children, thereby providing a lower seat 20. A larger bucket 12, such as a 7-gallon pail, may be used by adults. The bucketbasket 10 may be colored and decorated according to the user's preferences. For example, when a family goes fishing, each person may have their own bucketbasket 10, each identified by, for example, a different color.

A net assembly 30, as described in greater detail below, may be disposed inside of the bucket 12. The net assembly 30 may include a top member (also referred to as top ring) 32 sized to rest on a lip 24 of the container 16, thereby preventing the net assembly 30 from collapsing inside of the container 16.

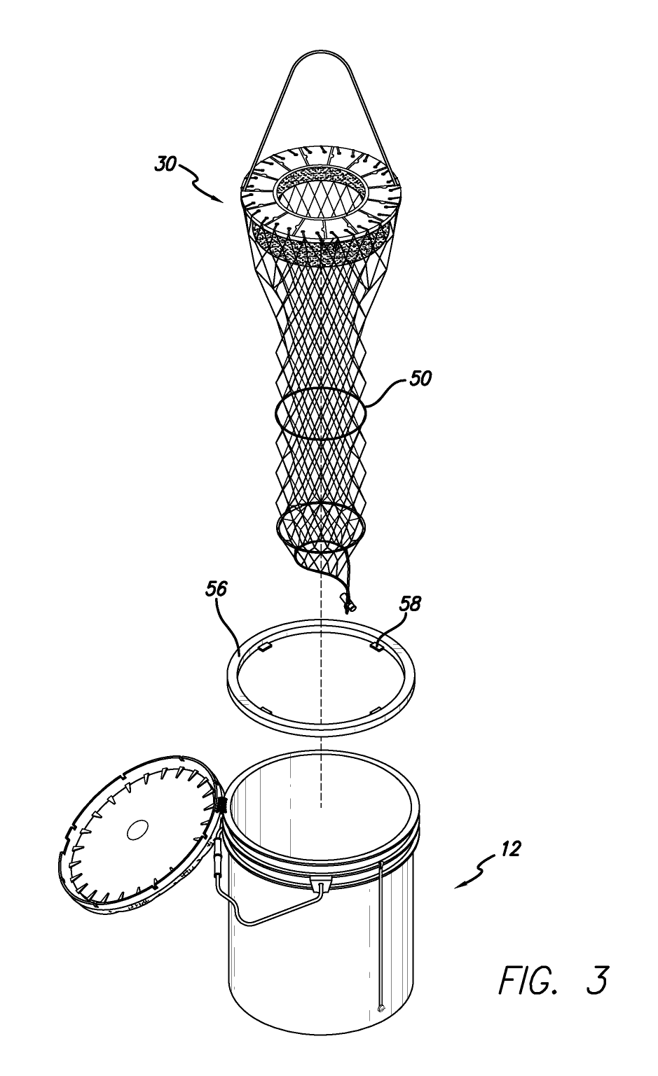

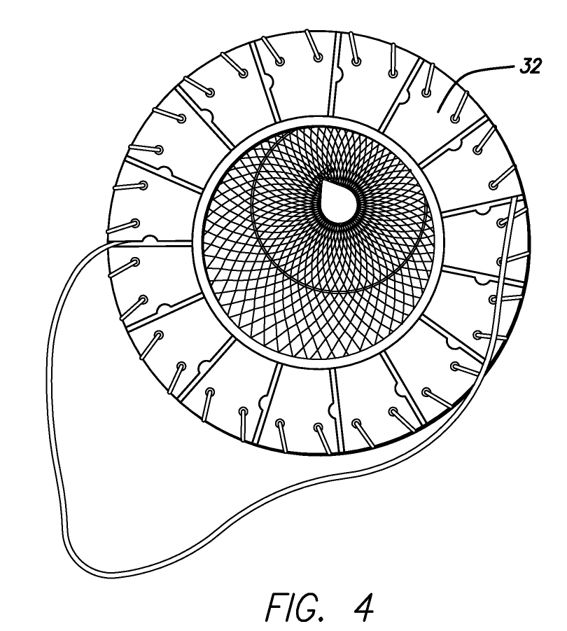

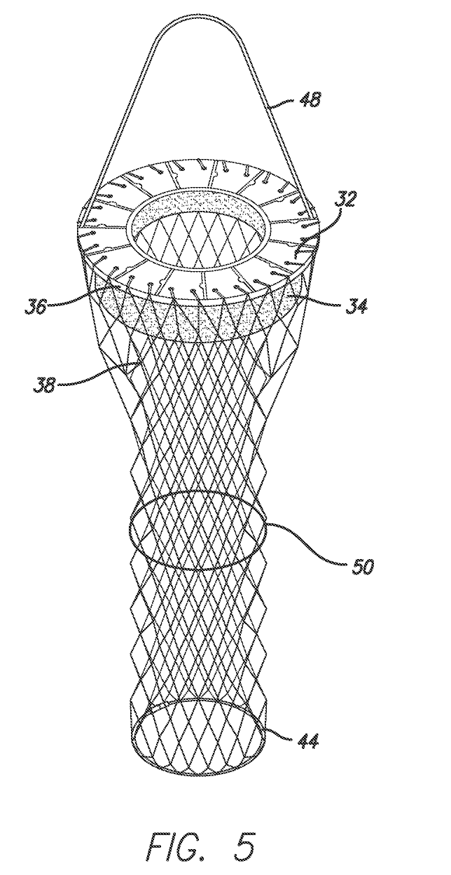

Referring now to FIGS. 3 through 5, the net assembly 30 includes a float ring 34 disposed at a top end of the net assembly 30. The float ring 34 is adapted to float in water. In one embodiment, the float ring 34 may be made of foam, such as Styrofoam. In other embodiments, the float ring 34 may be made of a hollow member, such as a hollow, round tubular member. This hollow member may be made of, for example, plastic. The top member 32 may be attached to the float ring 34, by for example, stitching as shown in FIG. 3. Alternatively, the top member 32 may be formed as a one-piece member with the float ring 34.

When disposed inside the bucket 12, the top member 32 may abut against tabs 58 formed in a bucket top connector 56. The bucket top connector 56 may fit around the upper edge of the bucket 12. The tabs 58 of the bucket top connector 56 may hold the top member 32 at the top of the bucket 12 when there is no water in the bucket. There may be from about 2 to about 8 tabs formed around an inner periphery of the bucket top connector 56.

A ring 36 may be attached to the top member 32. The ring 36 may be a circular ring having an outside diameter smaller than an inside diameter of the container 16. The ring 36 may be made from solid plastic, hollow plastic, or metal, such as stainless steel. The ring 36 may be optional depending on the material of the top member 32 and the float ring 34. The ring 36 may help support the weight of fish inside a net 38 when lifting the net 38 out of the water or out of the bucket 12.

The net 38 may be attached to the ring 36. Alternatively, the net 38 may attach to the top member 32, the float ring 36 or, when these two elements are formed as a single piece, the combined top member/float ring. The net 38, when expanded, may have a tubular shape with openings on each end. One open end of the net 38 may be aligned with an opening in the float ring 34. The other open end 46 of the net 38 may include a drawstring 40 for closing this open end. The drawstring 40 may include a drawstring catch 42 adapted to maintain the drawstring 40 in a closed position.

A lower ring 44 may be positioned in the net at a position proximal to the open end 46 of the net 38 having the drawstring 40. In some embodiments, the lower ring 44 may be disposed a distance from the open end 46 of the net 38 so that the drawstring 40 may close the open end 46. The lower ring 44 may have made of a material that has a density greater than the density of water. This design may allow the lower ring 44 to sink in water, thereby permitting the net assembly 30 to be fully extended (from the float ring 34 to the sunken lower ring 44) when placed in water.

A middle ring 50 may be positioned approximately midway of the length of the net 38. The middle ring 50 may help position the net 38 in the water and also may help retain the shape of the net (for example, ring 50 may prevent the net from twisting), thereby allowing fish room to swim within the full length of the net.

The net 38 may be removably attached to each of the ring 36 and the lower ring 44 by, for example, tying, straps, tape and the like. This design may allow removal and replacement of the net 38, permitting new nets or differently sized nets to be installed in the net assembly 30. In some embodiments, the ring 36 may not be used and the net may attach directly to the float ring. In this embodiment, the float ring may have, for example, a plurality of snaps or some other fastener to connect the net to the float ring.

A net assembly handle 48 may be attached to the ring 36. The handle 48 may allow placement and removal of the net assembly 30 into water. The handle 48 may also be used to attach the net assembly 30 to a boat, for example. As the boat moves, the net assembly 30 may move along with the boat in water.

The bucketbasket 10 may be used as a seat. In addition, the bucketbasket 10 may be used to store the net assembly 30, which may be removed from the bucket 12 and placed in the water (such as in a lake) to store caught fish. If the person fishing is on shore and wants to change locations, lake water may be partially filled in the bucket 12 and the net assembly may be lifted out of the water (with the fish therewith) and placed in the bucket 12. The bucketbasket 10 (with the fish and water inside) may be moved to another location and the net assembly 30 may be removed and placed in the water again. When fishing from a boat, the net assembly 30 may be attached to the boat (by the handle 48) and the floating ring 34 may float on the water, with the net 38 extending below the floating ring 34, under the water. When fish are caught, they may be placed into the net assembly 30.

As shown in FIG. 3, the net assembly 30, when extended, may be larger than the inside area of the bucket 12. This may give caught fish stored in the net assembly 30 room to swim about at various depths.

The bucketbasket 10 may also include an apron (not shown) around the bucket 12. The apron may hold, for example, fishing tackle. The bucketbasket 10 may not only be used for fish caught, but may also be used to hold bait fish, keeping them alive until they are ready for use.

It should be understood, of course, that the foregoing relates to exemplary embodiments of the invention and that modifications may be made without departing from the spirit and scope of the invention as set forth in the following claims.

What is claimed is:

1. A fish keeping system comprising:
a bucket having a container portion and a lid portion;
a net assembly adapted to fit inside the bucket;
a float ring attached to one end of the net assembly;
a first ring attached to a portion of a net extending from the float ring; and
a second ring attached to the net proximal to an opening at a second end of the net.

2. The fish keeping system of claim 1, further comprising a seat on an exterior surface of the lid.

3. The fish keeping system of claim 2, further comprising a cushion on the seat.

4. The fish keeping system of claim 1, further comprising a handle for carrying the system.

5. The fish keeping system of claim 1, further comprising a net assembly handle attached to and extending from the net assembly.

6. The fish keeping system of claim 1, further comprising a top ring connected to the float ring.

7. The fish keeping system of claim 6, wherein the first ring is attached to the top ring.

8. The fish keeping system of claim 1, further comprising a drawstring for closing the opening in the net.

9. The fish keeping system of claim 1, wherein the net, when expanded, has an inside volume larger than the volume of the bucket.

10. The fish keeping system of claim 1, wherein the float ring is a hollow plastic ring.

11. The fish keeping system of claim 1, wherein the float ring is a foam ring.

12. The fish keeping system of claim 1, wherein the second ring has a density greater than the density of water.

13. The fish keeping system of claim 1, wherein the lid is attached to the container with a hinge.

14. The fish keeping system of claim 1, wherein the bucket has a size selected from the group consisting of 3 gallons, 5 gallons and 7 gallons.

15. A bucketbasket comprising:
a bucket having a container portion and a lid portion;
a net assembly adapted to fit inside the bucket;
a float ring attached to one end of the net assembly;
a first ring attached to a first end of a net extending from the float ring;
a second ring attached to the net proximal to an opening at a second end of the net;
a cushioned seat on an exterior surface of the lid;
a handle for carrying the system; and
a net assembly handle attached to and extending from the net assembly.

16. The bucketbasket of claim 15, further comprising a drawstring for closing the opening in the net.

17. The bucketbasket of claim 16, further comprising a catch for keeping the drawstring in a closed position.

18. The bucketbasket of claim 16, wherein the net, when expanded, has an inside volume larger than the volume of the bucket.
